(19) United States
(12) Patent Application Publication
(10) Pub. No.: US 2024/0273597 A1
(43) Pub. Date: Aug. 15, 2024

(54) PRODUCT COMPARISON AND UPGRADE IN A VIRTUAL ENVIRONMENT

(71) Applicant: Apple Inc., Cupertino, CA (US)

(72) Inventors: Brendan J. SCULLY, Cos Cob, CT (US); Alexander B. OSER, Minneapolis, MN (US); Wilson W. YIN, Cupertino, CA (US); Yang LIU, Sunnyvale, CA (US); Brandel C. ZACHERNUK, Sunnyvale, CA (US); Jaewoong HWANG, Sunnyvale, CA (US); Weixuan ZHAO, Santa Clara, CA (US); Wai Ki CHAN, Mountain View, CA (US)

(21) Appl. No.: 18/587,653

(22) Filed: Feb. 26, 2024

Related U.S. Application Data
(63) Continuation of application No. PCT/US2022/075480, filed on Aug. 25, 2022.
(60) Provisional application No. 63/237,925, filed on Aug. 27, 2021.

(51) Int. Cl. G06Q 30/0601; G06T 7/20; G06T 19/20

(52) U.S. Cl. CPC G06Q 30/0629; G06Q 30/0643; G06T 7/20; G06T 19/20; G06T 2219/2004; G06T 2219/2016

(57) ABSTRACT

Some embodiments described in this disclosure are directed to methods for comparing products in a three-dimensional environment. In particular, some embodiments described in this disclosure are directed to methods for comparing physical objects (e.g., physical products) and virtual object representations in the three-dimensional environment. These comparisons can provide an efficient and intuitive way for a user to identify differences between a particular physical object and a virtual object representation, and enable a user to select an upgrade or replacement for the physical object. Some embodiments described in this disclosure are directed to methods for presenting object information for a physical object in a three-dimensional environment, and comparing the physical object to a virtual upgrade object.

### CROSS-REFERENCE TO RELATED APPLICATIONS

This application is a continuation of International Application No. PCT/US2022/075480, filed Aug. 25, 2022, which claims the benefit of U.S. Provisional Application No. 63/237,925, filed Aug. 27, 2021, the contents of which are herein incorporated by reference in their entireties for all purposes.

### FIELD OF THE DISCLOSURE

This relates generally to methods for comparing objects in a virtual environment.

### BACKGROUND OF THE DISCLOSURE

Computer-generated environments are environments where at least some objects displayed for a user's viewing are generated using a computer, and in some instances, some displayed objects are physical objects. Users may interact with a computer-generated environment by interacting with both computer-generated and physical objects.

### SUMMARY OF THE DISCLOSURE

Some embodiments described in this disclosure are directed to methods for comparing objects in a three-dimensional environment. In particular, some embodiments described in this disclosure are directed to methods for comparing physical objects (e.g., physical products) and virtual object representations (e.g., virtual product representations) in the three-dimensional environment. These comparisons can provide an efficient and intuitive way for a user to identify differences between a particular physical object and a virtual object representation, and enable a user to select an upgrade or replacement for the physical object. Some embodiments described in this disclosure are directed to methods for presenting object ownership information for a physical object in a three-dimensional environment, and comparing the physical object to a virtual upgrade object. The full descriptions of the embodiments are provided in the Drawings and the Detailed Description, and it is understood that this Summary does not limit the scope of the disclosure in any way.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates an electronic device displaying an extended reality environment according to some embodiments of the disclosure.

FIG. 2 illustrates a block diagram of an exemplary architecture for a system or device in accordance with some embodiments of the disclosure.

FIG. 3A illustrates a 3D environment including a physical product for comparison with one or more virtual representations of one or more products according to some embodiments of the disclosure.

FIG. 3B illustrates a physical product being brought into close proximity to a virtual product representation in a product card to initiate a comparison between the physical product and a product associated with that product card according to some embodiments of the disclosure.

FIG. 3C illustrates a virtual product representation in a comparison position with respect to a physical product according to some embodiments of the disclosure.

FIG. 3D illustrates the comparison of a physical product to a virtual product representation according to some embodiments of the disclosure.

FIG. 3E illustrates another comparison of a physical product to a virtual product representation according to some embodiments of the disclosure.

FIG. 3F illustrates yet another comparison of a physical product to a virtual product representation according to some embodiments of the disclosure.

FIG. 3G illustrates yet another comparison of a physical product to a virtual product representation according to some embodiments of the disclosure.

FIG. 4A illustrates a 3D environment including a physical product and a virtual product information card according to some embodiments of the disclosure.

FIG. 4B illustrates the selection of a window affordance from within a virtual product information card according to some embodiments of the disclosure.

FIG. 4C illustrates a 3D environment displaying further product information presented due to the selection of a window affordance according to some embodiments of the disclosure.

FIG. 5 is a flow diagram illustrating a method of comparing a physical product to a virtual product representation in a 3D environment according to some embodiments of the disclosure.

FIG. 6 is a flow diagram illustrating a method of displaying and utilizing product ownership information of a physical product in a 3D environment according to some embodiments of the disclosure.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used and structural changes are optionally made without departing from the scope of the disclosed embodiments. Further, although the following description uses terms “first,” “second,” etc. to describe various elements, these elements should not be limited by the terms. These terms are only used to distinguish one element from another. For example, a respective representation could be referred to as a “first” or “second” representation, without implying that the respective representation has different characteristics based merely on the fact that the respective representation is referred to as a “first” or “second” representation. On the other hand, a representation referred to as a “first” representation and a representation referred to as a “second” representation are both representation, but are not the same representation, unless explicitly described as such.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as personal digital assistant and/or music player functions. Other portable electronic devices, such as laptops or tablet computers with touch-sensitive surfaces (e.g., touch screen displays and/or touch pads), are optionally used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces/computer generated environments of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad).

In the description herein, an electronic device that includes a display generation component for displaying a computer-generated environment optionally includes one or more input devices. In some embodiments, the one or more input devices includes a touch-sensitive surface as a means for the user to interact with the user interface or computer-generated environment (e.g., finger contacts and gestures on the touch-sensitive surface). It should be understood, however, that the electronic device optionally includes or receives input from one or more other input devices (e.g., physical user-interface devices), such as a physical keyboard, a mouse, a stylus and/or a joystick (or any other suitable input device).

In some embodiments, the one or more input devices can include one or more cameras and/or sensors that is able to track the user's gestures and interpret the user's gestures as inputs. For example, the user may interact with the user interface or computer-generated environment via eye focus (gaze) and/or eye movement and/or via position, orientation or movement of one or more fingers/hands (or a representation of one or more fingers/hands) in space relative to the user interface or computer-generated environment. In some embodiments, eye focus/movement and/or position/orientation/movement of fingers/hands can be captured by cameras and other sensors (e.g., motion sensors). In some embodiments, audio/voice inputs can be used to interact with the user interface or computer-generated environment captured by one or more audio sensors (e.g., microphones). Further, as described above, it should be understood that the described electronic device, display and touch-sensitive surface and/or other input devices/sensors are optionally distributed amongst two or more devices.

Therefore, as described herein, information displayed on the electronic device or by the electronic device is optionally used to describe information output by the electronic device for display on a separate display device (touch-sensitive or not). Similarly, as described herein, input received on the electronic device (e.g., touch input received on a touch-sensitive surface of the electronic device) is optionally used to describe input received on a separate input device, from which the electronic device receives input information.

The device typically supports a variety of applications that may be displayed in the computer-generated environment, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a content application (e.g., a photo/video management application), a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed via the device are, optionally, adjusted and/or varied from one application to the next and/or within a respective application. In this way, a common physical architecture (such as the touch-sensitive surface or other input device/sensor) of the device optionally supports the variety of applications with user interfaces that are intuitive and transparent to the user.

Some embodiments described in this disclosure are directed to methods for comparing objects in a three-dimensional environment. In particular, some embodiments described in this disclosure are directed to methods for comparing physical objects (e.g., physical products) and virtual object representations (e.g., virtual product representations) in the three-dimensional environment. These comparisons can provide an efficient and intuitive way for a user to identify differences between a particular physical object and a virtual object representation, and enable a user to select an upgrade or replacement for the physical object. Some embodiments described in this disclosure are directed to methods for presenting object ownership information for a physical object in a three-dimensional environment, and comparing the physical object to a virtual upgrade object.

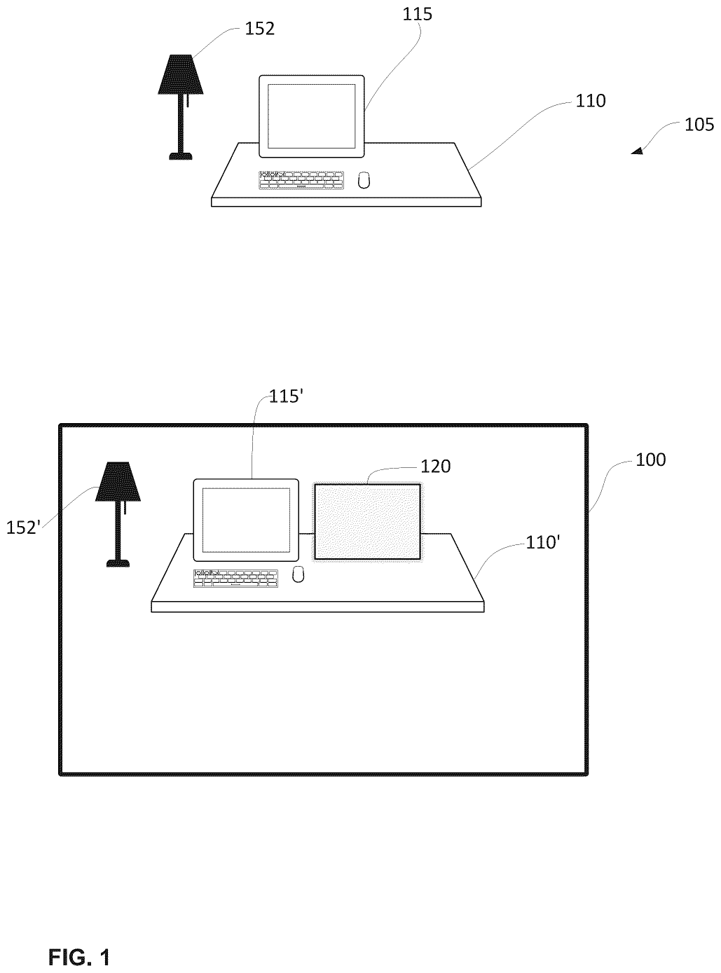

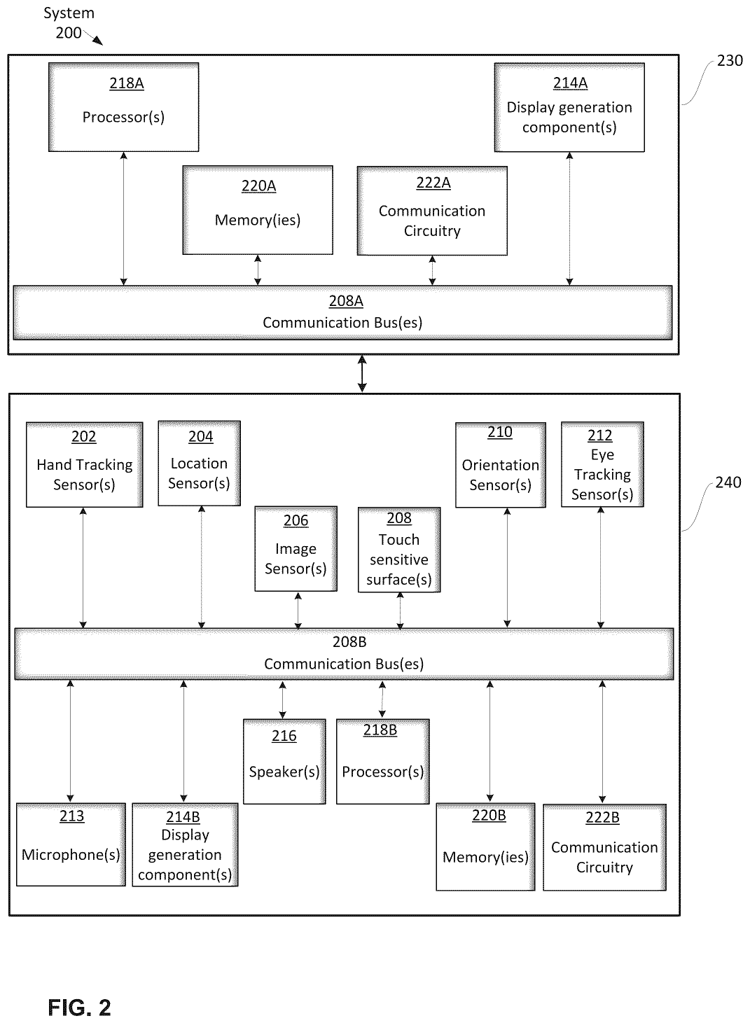

FIG. 1 illustrates an electronic device 100 displaying an extended reality (XR) environment (e.g., a computer-generated environment) according to embodiments of the disclosure. In some embodiments, electronic device 100 is a hand-held or mobile device, such as a tablet computer, laptop computer, smartphone, or head-mounted display. Additional examples of device 100 are described below with reference to the architecture block diagram of FIG. 2. As shown in FIG. 1, electronic device 100 and tabletop 110 are located in the physical environment 105. The physical environment may include physical features such as a physical surface (e.g., floor, walls) or a physical object (e.g., table, lamp, etc.). In some embodiments, electronic device 100 may be configured to capture areas of physical environment 105 including tabletop 110, lamp 152, desktop computer 115 and input devices 116 (illustrated in the field of view of electronic device 100). In some embodiments, in response to a trigger, the electronic device 100 may be configured to display a virtual object 120 in the computer-generated environment (e.g., represented by an application window illustrated in FIG. 1) that is not present in the physical environment 105, but is displayed in the computer-generated environment positioned on (e.g., anchored to) the top of a computer-generated representation 110′ of real-world table top 110. For example, virtual object 120 can be displayed on the surface of the tabletop 110′ in the computer-generated environment displayed via device 100 in response to detecting the planar surface of tabletop 110 in the physical environment 105.

It should be understood that virtual object 120 is a representative virtual object and one or more different virtual objects (e.g., of various dimensionality such as two-dimensional or three-dimensional virtual objects) can be included and rendered in a three-dimensional computer-generated environment. For example, the virtual object can represent an application or a user interface displayed in the computer-generated environment. In some embodiments, the virtual object 120 is optionally configured to be interactive and responsive to user input, such that a user may virtually touch, tap, move, rotate, or otherwise interact with, the virtual object. Additionally, it should be understood that, as used herein, the three-dimensional (3D) environment (or 3D virtual object) may be a representation of a 3D environment (or three-dimensional virtual object) projected or presented at an electronic device.

In the discussion that follows, an electronic device that is in communication with a display generation component and one or more input devices is described. It should be understood that the electronic device optionally is in communication with one or more other physical user-interface devices, such as touch-sensitive surface, a physical keyboard, a mouse, a joystick, a hand tracking device, an eye tracking device, a stylus, etc. Further, as described above, it should be understood that the described electronic device, display and/or touch-sensitive surface are optionally distributed amongst two or more devices. Therefore, as used herein, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

In some embodiments, the electronic device supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an exemplary architecture for a system or device 220 according to embodiments of the disclosure. In some embodiments, device 200 is a mobile device, such as a mobile phone (e.g., smart phone), a tablet computer, a laptop computer, a desktop computer, a head-mounted display, an auxiliary device in communication with another device, etc. In some embodiments, device 200 includes various sensors (e.g., one or more hand tracking sensor(s), one or more location sensor(s), one or more image sensor(s), one or more touch-sensitive surface(s), one or more motion and/or orientation sensor(s), one or more eye tracking sensor(s), one or more microphone(s) or other audio sensors, etc.), one or more display generation component(s), one or more speaker(s), one or more processor(s), one or more memories, and/or communication circuitry. One or more communication buses are optionally used for communication between the above-mentioned components of device 200.

In some embodiments, as illustrated in FIG. 2, system/device 200 can be divided between multiple devices. For example, a first device 230 optionally includes processor(s) 218A, memory or memories 220A, communication circuitry 222A, and display generation component(s) 214A optionally communicating over communication bus(es) 208A. A second device 240 (e.g., corresponding to device 200) optionally includes various sensors (e.g., one or more hand tracking sensor(s) 202, one or more location sensor(s) 204, one or more image sensor(s) 206, one or more touch-sensitive surface(s) 209, one or more motion and/or orientation sensor(s) 210, one or more eye tracking sensor(s) 212, one or more microphone(s) 213 or other audio sensors, etc.), one or more display generation component(s) 214B, one or more speaker(s) 216, one or more processor(s) 218B, one or more memories 220B, and/or communication circuitry 222B. One or more communication buses 208B are optionally used for communication between the above-mentioned components of device 240. In some embodiments, first device 230 and second device 240 communicate via a wired or wireless connection (e.g., via communication circuitry 222A-222B) between the two devices.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®.

Processor(s) 218A, 218B may include one or more general processors, one or more graphics processors, and/or one or more digital signal processors. In some embodiments, memory 220A, 220B is a non-transitory computer-readable storage medium (e.g., flash memory, random access memory, or other volatile or non-volatile memory or storage) that stores computer-readable instructions configured to be executed by processor(s) 218A, 218B to perform the techniques, processes, and/or methods described below. In some embodiments, memory 220A, 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some embodiments, the storage medium is a transitory computer-readable storage medium. In some embodiments, the storage medium is a non-transitory computer-readable storage medium. For example, the non-transitory computer-readable storage medium can include, but is not limited to, magnetic, optical, and/or semiconductor storages. In some embodiments, such storage may include magnetic disks, optical discs based on CD, DVD, or Blu-ray technologies, as well as persistent solid-state memory such as flash, solid-state drives, and the like.

In some embodiments, display generation component(s) 214A, 214B include a single display (e.g., a liquid-crystal display (LCD), organic light-emitting diode (OLED), or other types of display). In some embodiments, display generation component(s) 214A, 214B includes multiple displays. In some embodiments, display generation component(s) 214A, 214B can include a display with touch capability (e.g., a touch screen), a projector, a holographic projector, a retinal projector, etc. In some embodiments, device 240 includes touch-sensitive surface(s) 209 for receiving user inputs, such as tap inputs and swipe inputs or other gestures. In some embodiments, display generation component(s) 214B and touch-sensitive surface(s) 209 form touch-sensitive display(s) (e.g., a touch screen integrated with device 240 or external to device 240 that is in communication with device 240).

Device 240 optionally includes image sensor(s) 206. In some embodiments, image sensors(s) 206 optionally include one or more visible light image sensors, such as charged coupled device (CCD) sensors, and/or complementary metal-oxide-semiconductor (CMOS) sensors operable to obtain images of physical objects from the real-world environment. Image sensor(s) 206 also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206 also optionally include one or more cameras configured to capture movement of physical objects in the real-world environment. Image sensor(s) 206 also optionally include one or more depth sensors configured to detect the distance of physical objects from device 240. In some embodiments, information from one or more depth sensors can allow the device to identify and differentiate objects in the real-world environment from other objects in the real-world environment. In some embodiments, one or more depth sensors can allow the device to determine the texture and/or topography of objects in the real-world environment.

In some embodiments, device 240 uses CCD sensors, event cameras, and depth sensors in combination to detect the physical environment around device 240. In some embodiments, image sensor(s) 206 include a first image sensor and a second image sensor. The first image sensor and the second image sensor work in tandem and are optionally configured to capture different information of physical objects in the real-world environment. In some embodiments, the first image sensor is a visible light image sensor, and the second image sensor is a depth sensor. In some embodiments, device 240 uses image sensor(s) 206 to detect the position and orientation of device 240 and/or display generation component(s) 214 in the real-world environment. For example, device 240 uses image sensor(s) 206 to track the position and orientation of display generation component(s) 214B relative to one or more fixed objects in the real-world environment.

In some embodiments, device 240 includes microphone(s) 213 or other audio sensors. Device 240 uses microphone(s) 213 to detect sound from the user and/or the real-world environment of the user. In some embodiments, microphone(s) 213 includes an array of microphones (a plurality of microphones) that optionally operate in tandem, such as to identify ambient noise or to locate the source of sound in space of the real-world environment.

Device 240 includes hand tracking sensor(s) 202 and/or eye tracking sensor(s) 212, in some embodiments. Hand tracking sensor(s) 202 are configured to track the position/location of one or more portions of the user's hands, and/or motions of one or more portions of the user's hands with respect to the extended reality environment, relative to the display generation component(s) 214B, and/or relative to another defined coordinate system. In some embodiments, eye tracking senor(s) 212 are configured to track the position and movement of a user's gaze (eyes, face, or head, more generally) with respect to the real-world or extended reality environment and/or relative to the display generation component(s) 214B. In some embodiments, hand tracking sensor(s) 202 and/or eye tracking sensor(s) 212 are implemented together with the display generation component(s) 214B. In some embodiments, the hand tracking sensor(s) 202 and/or eye tracking sensor(s) 212 are implemented separate from the display generation component(s) 214B.

In some embodiments, the hand tracking sensor(s) 202 can use image sensor(s) 206 (e.g., one or more IR cameras, 3D cameras, depth cameras, etc.) that capture three-dimensional information from the real-world including one or more hands (e.g., of a human user). In some embodiments, the hands can be resolved with sufficient resolution to distinguish fingers and their respective positions. In some embodiments, one or more image sensor(s) 206 are positioned relative to the user to define a field of view of the image sensor(s) 206 and an interaction space in which finger/hand position, orientation and/or movement captured by the image sensors are used as inputs (e.g., to distinguish from a user's resting hand or other hands of other persons in the real-world environment). Tracking the fingers/hands for input (e.g., for detecting gestures, touch, tap, etc.) can be advantageous in that it does not require the user to touch, hold or wear any sort of beacon, sensor, or other marker.

In some embodiments, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some embodiments, both eyes are tracked separately by respective eye tracking cameras and illumination sources, and a focus/gaze can be determined from tracking both eyes. In some embodiments, one eye (e.g., a dominant eye) is tracked by a respective eye tracking camera/illumination source(s).

Device 240 includes location sensor(s) 204 for detecting a location of device 240 and/or display generation component(s) 214B. For example, location sensor(s) 204 can include a GPS receiver that receives data from one or more satellites and allows device 240 to determine the device's absolute position in the physical world.

Device 240 includes orientation sensor(s) 210 for detecting orientation and/or movement of device 240 and/or display generation component(s) 214B. For example, device 240 uses orientation sensor(s) 210 to track changes in the position and/or orientation of device 240 and/or display generation component(s) 214B, such as with respect to physical objects in the real-world environment. Orientation sensor(s) 210 optionally include one or more gyroscopes and/or one or more accelerometers.

It should be understood that system/device 200 is not limited to the components and configuration of FIG. 2, but can include fewer, alternative, or additional components in multiple configurations. In some embodiments, system 200 can be implemented in a single device. A person using system 200, is optionally referred to herein as a user of the device.

As described herein, a computer-generated environment including various graphics user interfaces (“GUIs”) may be displayed using an electronic device, such as electronic device 100 or device 200, including one or more display generation components. The computer-generated environment can include one or more GUIs associated with an application.

In some embodiments, locations in a computer-generated environment (e.g., a three-dimensional environment, an XR environment, a mixed reality environment, etc.) optionally have corresponding locations in the physical environment. Thus, when a device is described as displaying a virtual object at a respective location with respect to a physical object (e.g., such as a location at or near the hand of the user, or at or near a physical table), the device displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment can interact with virtual objects that exist only in the three-dimensional environment. For example, a three-dimensional environment can include a table and a user interface located in front of the table, with the table being a view of (or a representation of) a physical table in the physical environment, and the user interface being a virtual object.

Similarly, a user is optionally able to interact with virtual objects in the three-dimensional environment (e.g., such as user interfaces of applications running on the device) using one or more hands as if the virtual objects were real objects in the physical environment. For example, as described above, one or more sensors of the device optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment (e.g., grabbing, moving, touching, pointing at virtual objects, etc.) as if they were real physical objects in the physical environment. In some embodiments, a user is able to move his or her hands to cause the representations of the hands in the three-dimensional environment to move in conjunction with the movement of the user's hand. As used herein, reference to a physical object such as hand can refer to either a representation of that physical object presented on a display, or the physical object itself as passively provided by a transparent or translucent display.

In some of the embodiments described below, the device is optionally able to determine the “effective” distance between physical objects in the physical world and virtual objects in the three-dimensional environment, for example, for the purpose of determining whether a physical object is interacting with a virtual object (e.g., whether a hand is touching, grabbing, holding, etc. a virtual object or within a threshold distance from a virtual object). For example, the device determines the distance between the hands of the user and virtual objects when determining whether the user is interacting with virtual objects and/or how the user is interacting with virtual objects. In some embodiments, the device determines the distance between the hands of the user and a virtual object by determining the distance between the location of the hands in the three-dimensional environment and the location of the virtual object of interest in the three-dimensional environment. For example, the one or more hands of the user can be located at a particular position in the physical world, which the device optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared against the position of the virtual object of interest in the three-dimensional environment to determine the distance between the one or more hands of the user and the virtual object. In some embodiments, the device optionally determines a distance between a physical object and a virtual object by comparing positions in the physical world (e.g., as opposed to comparing positions in the three-dimensional environment). For example, when determining the distance between one or more hands of the user and a virtual object, the device optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the device optionally performs any of the techniques described above to map the location of the physical object to the three-dimensional environment and/or map the location of the virtual object to the physical world.

In some embodiments, the same or similar technique is used to determine where and what the gaze of the user is directed to. For example, if the gaze of the user is directed to a particular position in the physical environment, the device optionally determines the corresponding position in the three-dimensional environment and if a virtual object is located at that corresponding virtual position, the device optionally determines that the gaze of the user is directed to that virtual object.

Similarly, the embodiments described herein may refer to the location of the user (e.g., the user of the device) and/or the location of the device in the three-dimensional environment. In some embodiments, the user of the device is holding, wearing, or otherwise located at or near the electronic device. Thus, in some embodiments, the location of the device is used as a proxy for the location of the user. In some embodiments, the location of the device and/or user in the physical environment corresponds to a respective location in the three-dimensional environment. In some embodiments, the respective location is the location from which the “camera” or “view” of the three-dimensional environment extends. For example, the location of the device would be the location in the physical environment (and its corresponding location in the three-dimensional environment) from which, if a user were to stand at that location facing the respective portion of the physical environment displayed by the display generation component, the user would see the objects in the physical environment in the same position, orientation, and/or size as they are displayed by the display generation component of the device (e.g., in absolute terms and/or relative to each other). Similarly, if the virtual objects displayed in the three-dimensional environment were physical objects in the physical environment (e.g., placed at the same location in the physical environment as they are in the three-dimensional environment, and having the same size and orientation in the physical environment as in the three-dimensional environment), the location of the device and/or user is the position at which the user would see the virtual objects in the physical environment in the same position, orientation, and/or size as they are displayed by the display generation component of the device (e.g., in absolute terms and/or relative to each other and the real world objects).

Some embodiments described herein may refer to selection inputs as either discrete inputs or as continuous inputs. For example, a selection input can correspond to a single selection input or a selection input can be held (e.g., maintained) while performing one or more other gestures or inputs. In some embodiments, a selection input can have an initiation stage, a holding stage, and a termination stage. For example, in some embodiments, a pinch gesture by a hand of the user can be interpreted as a selection input. In this example, the motion of the hand into a pinch position can be referred to as the initiation stage and the device is able to detect that the user has initiated a selection input. The holding stage refers to the stage at which the hand maintains the pinch position. Lastly, the termination stage refers to the motion of the hand terminating the pinch position (e.g., releasing the pinch). In some embodiments, if the holding stage is less than a predetermined threshold amount of time (e.g., less than 0.1 seconds, 0.3 seconds, 0.5 seconds, 1 second, 2 seconds, etc.), then the selection input is interpreted as a discrete selection input (e.g., a single event actuating a respective user interface element), such as a mouse click-and-release, a keyboard button press-and-release, etc. In such embodiments, the electronic device optionally reacts to the discrete selection event (e.g., optionally after detecting the termination). In some embodiments, if the holding stage is more than the predetermined threshold amount of time, then the selection input is interpreted as a select-and-hold input, such as a mouse click-and-hold, a keyboard button press-and-hold, etc. In such embodiments, the electronic device can react to not only the initiation of the selection input (e.g., initiation stage), but also to any gestures or events detected during the holding stage (e.g., such as the movement of the hand that is performing the selection gesture), and/or the termination of the selection input (e.g., termination stage).

In some embodiments, extended reality environments (e.g., such as a three-dimensional (3D) environment) are able to provide a virtual retail experience by displaying one or more product displays in a manner similar to a physical retail store (e.g., a brick-and-mortar store). In some embodiments, the virtual retail experience can provide the user with the ability to compare one or more features of a physical product (e.g., the user's currently owned product) to other virtual products (e.g., newer versions of the same product, or different models of a similar product), for example, as if the user were physically in a retail store and physically manipulating a product (e.g., with one or more hands) in contemplation of a product upgrade, for example. In other embodiments, the virtual retail experience can provide the user with the ability to compare one or more features of a virtual representation of a physical product (e.g., a representation of the user's currently owned product that is not presently available to the user in the physical environment) to other virtual products (e.g., newer versions of the virtual product, or different models of a similar product). In some embodiments, the comparison can include a partially or fully immersive experience, as will be described in more detail below. Although the paragraphs and figures referenced herein primarily utilize the term “product” for ease of explanation, in the various examples described herein, any type of object can be presented, compared, upgraded. etc. according to the various embodiments of the disclosure.

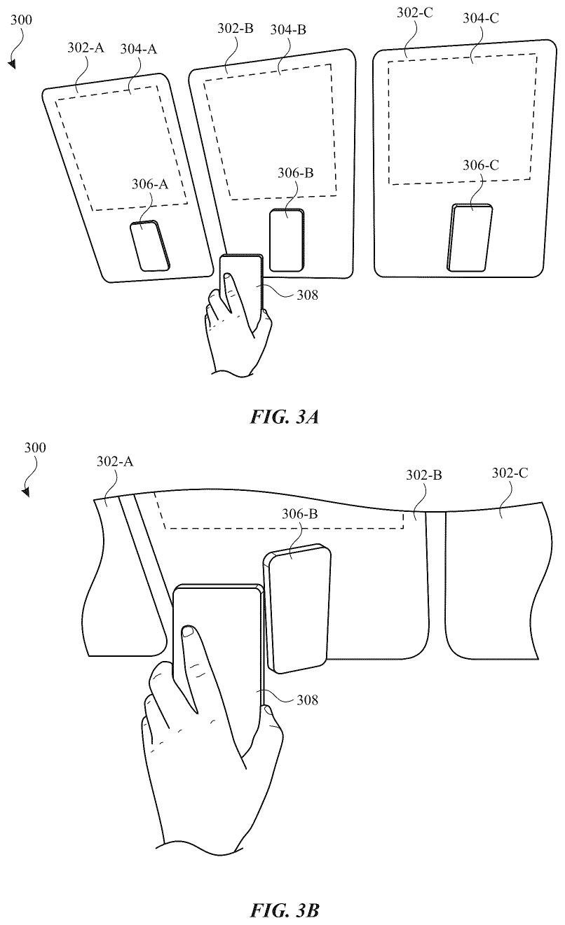

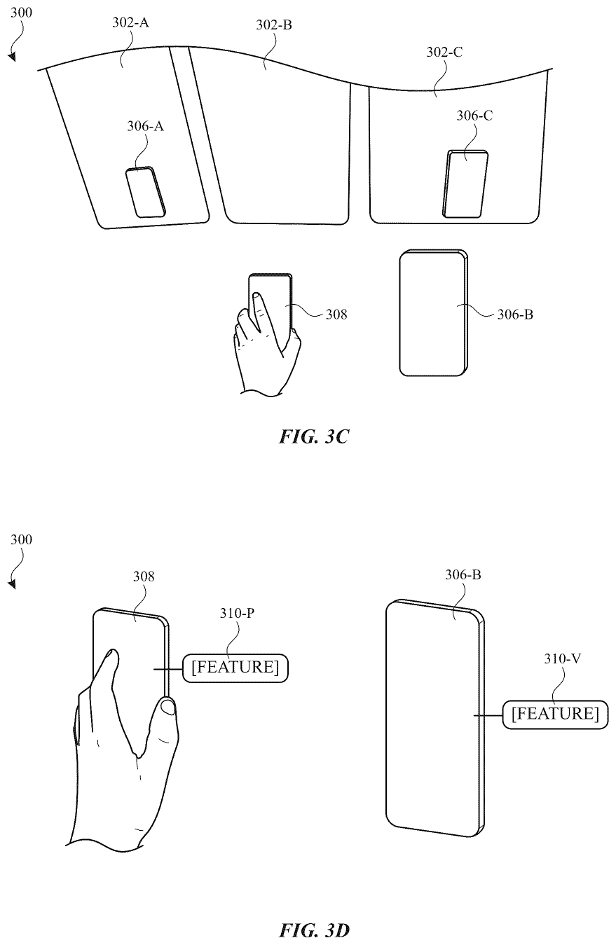

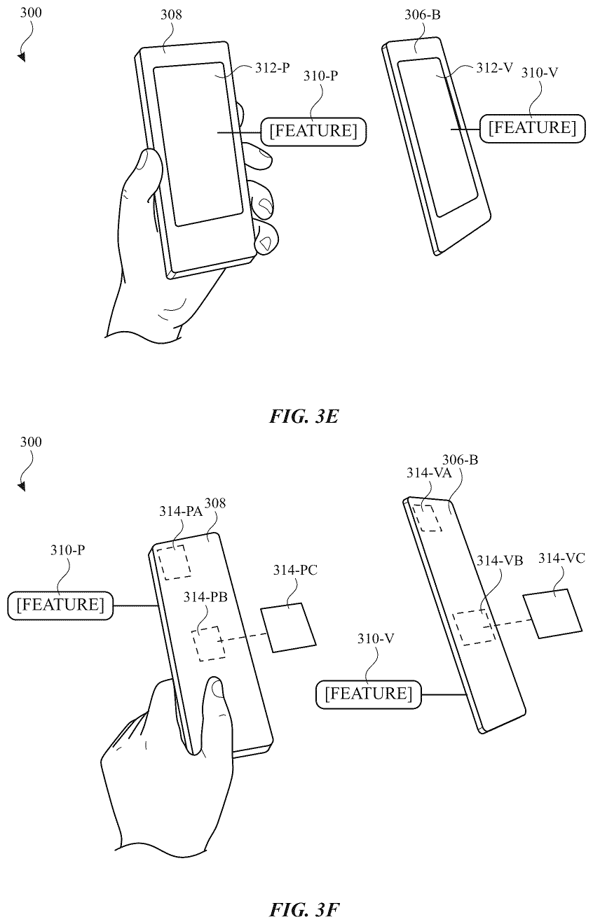

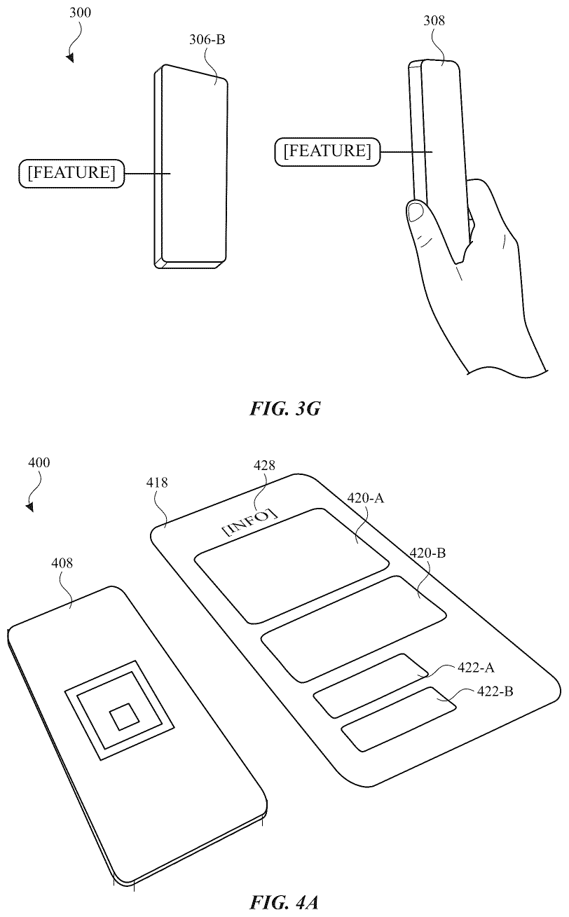

FIG. 3A illustrates 3D environment 300 including physical product 308 for comparison with one or more virtual representations of one or more products according to some embodiments of the disclosure. In the embodiment of FIG. 3A, 3D environment 300 can be displayed or presented (e.g., provided) by a display generation component of an electronic device (e.g., such as electronic device 100 and/or device 200 described above with respect to FIG. 1 and FIG. 2). One or more product cards 302 can be presented in 3D environment 300 and arranged as a virtual product station or in any other arrangement, including a random arrangement. Although product cards 302 (e.g., object cards) are shown in FIG. 3A as being generally rectangular and two-dimensional and suspended in 3D environment 300, in other embodiments the product cards can have different shapes, can be three-dimensional, and can be positioned in other ways, such as arranged on a flat surface, for example. Each product card 302 in the virtual product station can be considered a virtual object and is a representation of a virtual product and may contain information about a particular product model, SKU, etc. that is available for comparison. The term “virtual product” or “virtual object,” as used herein, is intended to distinguish between actual physical products or objects that are present in the physical environment and also appear in the 3D environment, and those products that are not present in the physical environment but appear in the 3D environment for comparison purposes, although the virtual products may represent physical products that are available for purchase, for example. Three product cards 302-A, 302-B and 302-C are shown in the embodiment of FIG. 3A, although in other embodiments, more product cards can be presented, including some that do not come into view until 3D environment 300 is panned left or right, for example. In some embodiments, each product card 302 can include product information 304 (e.g., specifications, descriptions, advantages, etc.) about a product associated with that product card. Three areas of product information 304-A, 304-B and 304-C, one for each product card 302-A, 302-B, and 302-C, respectively, are shown in the example embodiment of FIG. 3A. In some embodiments, virtual product representations 306 can also be presented, which are virtual objects, images or other representations of the products associated with product cards 302. Virtual object or product representations or images 306 can be a two-dimensional or three-dimensional representation of a product, or alternatively a photo, thumbnail, animation, wire frame, line drawing, etc. Three virtual product representations 306-A, 306-B and 306-C, one for each product card 302-A, 302-B, and 302-C, are shown in the embodiment of FIG. 3A. Although virtual product representations 306 in product cards 302 in FIG. 3A depict a smartphone, representations of other types of products, either electronic or non-electronic, can also be presented for comparison. Furthermore, although FIG. 3A (and other figures that follow) and corresponding paragraphs illustrate and describe the comparison of a physical product to a plurality of virtual product representations, in other embodiments a representation of a non-physical product (e.g., a representation of an operating system) can be compared to a plurality of virtual non-physical product representations (e.g., other operating system versions).

To initiate a comparison of a physical product with one or more virtual products, physical product 308 is first brought into view in 3D environment 300. In FIG. 3A, the user's hand and physical product 308 can both be representations of real-world objects in the physical environment in proximity to an electronic device such as a head-mounted device (e.g., the user's hand and the physical product exist in the physical environment). In some embodiments, the user's hand and physical product 308 are displayed by a display generation component in the electronic device by capturing one or more images of the user's hand and the physical product (e.g., using one or more sensors of the electronic device, such as a camera and/or a depth sensor) and displaying a representation of the user's hand and the physical product (e.g., a photorealistic representation, a simplified representation, a caricature, etc.), respectively, in 3D environment 300. In some embodiments, the user's hand and physical product 308 are displayed in 3D environment 300 at a location such that it appears in the same or a similar location as in the real world (e.g., the same distance from the user, from the same perspective, etc.). In some embodiments, the user's hand and physical product 308 are passively provided by the electronic device via a transparent or translucent display (e.g., by not obscuring the user's view of the user's hand and the physical product, thus allowing the user's hand and the physical product to be visible to the user through a transparent or translucent display). Although FIG. 3A shows physical product 308 being brought into 3D environment 300 using a left hand of a user, the physical product can be brought into view by a right hand or any other physical supporting structure. Physical product 308 can be identified using visual indicators that are displayed, printed, or otherwise visible on the physical product (e.g., distinctive physical features, model numbers, serial numbers, QR codes, etc.), signals transmitted by the physical product, voice commands, or other inputs that can be received and detected by a head-mounted display, for example, although in other embodiments the physical product can be previously identified (e.g., known in advance without the need for real-time system inputs).

FIG. 3B illustrates physical product 308 being brought into close proximity to virtual product representation 306-B in product card 302-B to initiate a comparison between the physical product and a product associated with that product card according to some embodiments of the disclosure. In the embodiment of FIG. 3B, physical product 308 has been moved close enough to virtual product representation 306-B to satisfy a comparison criterion (e.g., within a predetermined far-field proximity threshold). When the comparison criterion is satisfied, a determination can be made as to whether physical product 308 (the physical object) corresponds to virtual product representation 306-B (the virtual object). In some examples, this correspondence can be satisfied when the physical object and the virtual object are of the same general type (e.g., both are smartphones, both are tablets, both are smart watches, etc.). In other examples, correspondence can be satisfied by one or more other criteria, such as physical and virtual objects of the same or similar model, manufacturer and/or price range, etc.). If physical and virtual object correspondence is satisfied, the image of virtual product representation 306-B can pull slightly away from product card 302-B, indicating that the virtual product representation has been selected for potential comparison (in contrast to virtual product representations in other cards, which have not been selected for potential comparison). In some embodiments, the movement of virtual product representation 306-B towards physical product 308 can be gradual and nonlinear, simulating the effect of magnetic attraction. However, in other embodiments virtual product representation 306-B may move in a different manner, may not move at all, or a sound can be emitted to indicate far-field proximity. In some embodiments, physical product 308 can be positioned adjacent to other areas of product card 302-B instead of in proximity to virtual product representation 306-B. In other embodiments, instead of, or in addition to the proximity of physical product 308, other inputs can be utilized to select a particular virtual product representation 306 or product card 302 for potential comparison, such as voice input, eye gaze data, or a hand gesture (e.g., pointing with the non-grasping hand to a particular virtual product representation or product card).

FIG. 3C illustrates virtual product representation 306-B in a comparison position with respect to (e.g., defined relative to) physical product 308 according to some embodiments of the disclosure. Referring back to FIG. 3B, in some embodiments physical product 308 can be moved even closer to virtual product representation 306-B (e.g., within a near-field predetermined proximity threshold) to cause the virtual product representation to relocate to the comparison position shown in FIG. 3C. In other embodiments, physical product 308 can persist (e.g., hover) in either far-field or near-field proximity to virtual product representation 306-B as shown in FIG. 3B for a predetermined amount of time to trigger the relocation of the virtual product representation to the comparison position shown in FIG. 3C. In still other embodiments, gesture, audio, or other inputs (e.g., movement such as shaking of physical product 308, voice commands, eye gaze data, etc.) can trigger the relocation of virtual product representation 306-B from its location on, or slightly apart from product card 302-B to the comparison position shown in FIG. 3C. Although the embodiment of FIG. 3C shows virtual product representation 306-B being relocated to a comparison position (e.g., removed from product card 302-B), in other embodiments the virtual product representation may remain attached to the card, and a copy of the virtual product representation may appear at the comparison position. Although FIG. 3C illustrates an approximate side-by-side comparison position, in other embodiments the comparison position can be elsewhere in 3D environment 300.

In other embodiments, multiple virtual product representations 306 can be selected as shown in FIG. 3B, and each selected virtual product representation can be presented in non-overlapping comparison positions in an extension of FIG. 3C.

FIG. 3D illustrates the comparison of physical product 308 to virtual product representation 306-B according to some embodiments of the disclosure. In the embodiment of FIG. 3D, as physical product 308 is rotated and moved about in 3D environment 300, virtual product representation 306-B automatically rotates and moves in a synchronized manner such that both the physical product and the virtual product representation show approximately the same perspective views. In embodiments with multiple virtual product representations 306 in multiple comparison positions, all virtual product representations can move in concert with the movement of physical product 308. For example, in FIG. 3D the back side or surface of physical product 308 has been made visible, and accordingly the back side or surface of virtual product representation 306-B is also made visible. To the extent that virtual product representation 306-B is a somewhat accurate, to-scale representation of a product, the comparison can be a coordinated spatial visual comparison of size, visible features, and aesthetics of the two products. One or more of device motion tracking, camera scene capture, scene processing, and gesture and depth sensing can be utilized to track physical product 308 and the user's hand(s) in 3D environment 300. Algorithms running in the electronic device can be employed to estimate the position and orientation of physical product 308 even when partially obscured by the user's grasping hand, so that virtual product representation 306-B can be similarly oriented.

In the embodiment of FIG. 3D, upon rotating physical product 308 at a certain angle or orientation to expose a particular surface or view of physical product 308, textual indicator (e.g., contextual label) 310-P automatically appears, pointing to a particular location on the physical product and presenting information such as a particular product specification, feature, advantage, characteristic, or the like. Textual indicators 310 can provide additional detailed comparison information not available in a simple visual comparison. Although FIG. 3D (and other figures herein) show the textual indicator as containing a generic “[Feature]” to simplify the illustration, it should be understood that the textual indicators can contain any type of information that can help a user compare products. In some embodiments, because the back side of virtual product representation 306-B is also visible, textual indicator 310-V also automatically appears, pointing to a location on the virtual product representation that is similar to the location on physical product 308 being pointed to by textual indicator 310-P. Textual indicator 310-V can present the same type of information presented in textual indicator 310-P (but with different values, as applicable), so that a user can compare the information for both the physical product and virtual product representation. Although FIG. 3D illustrates textual indicators 310 as ovals with text, in other embodiments the textual indicators can appear as different two-dimensional or three-dimensional shapes, and may contain information other than text, such as images, animations, videos, and the like. In some embodiments, textual indicators 310 can appear only with respect to physical product 308 or virtual product representation 306-B, but not both.

In a smartphone example, textual indicators 310 can include, but are not limited to, information such as the features of the camera system, battery life, display information (e.g., size, technology and resolution), user identification information (e.g., face recognition, fingerprint detection), environmental resistance information (e.g., water resistance, dust resistance), and processor information (e.g., type, model, technology, manufacturer, speed). However, it should be understood that other product types and other product information can be compared. Although textual indicators 310 in the embodiment of FIG. 3D include lines or pointers to a particular location on physical product 308 and virtual product representation 306-B, in other embodiments the lines or pointers may only point generally to the physical product or virtual product representation, but not to specific areas. In other embodiments, the lines or pointers may not exist at all, in which case textual indicators 310 can be positioned close enough to physical product 308 or virtual product representation 306-B to indicate which product is associated with a particular textual indicator.

In some embodiments, the physical product may be compared to virtual product representations that have some degree of dissimilarity. For example, instead of a physical smartphone being compared to a representation of an upgraded smartphone, the physical smartphone may be compared to a tablet computer with some, but not all, of the same features of the smartphone. In some embodiments, when either physical product 308 or virtual product representation 306 includes a particular feature but the other does not, textual indicator 310 will appear only for the product having that feature, which can inform a viewer that the feature is not available in the other product. In other embodiments, when either physical product 308 or virtual product representation 306 includes a particular feature but the other does not, no textual indicator 310 can appear for either product, which can allow the user to see filtered comparisons of only those features common to both products.

FIG. 3E illustrates another comparison of physical product 308 to virtual product representation 306-B according to some embodiments of the disclosure. In the embodiment of FIG. 3E, physical product 308 has been rotated to expose display 312-P, and virtual product representation 306-B has been similarly rotated to expose display 312-V. In the embodiment of FIG. 3E, textual indicators 310-P and 310-V have been automatically relocated to the left side of physical product 308 and virtual product representation 306-B, respectively (as compared to FIG. 3D). In general, textual indicators 310 can appear at different locations with respect to physical product 308 and virtual product representation 306-B, depending on how the products are oriented, the feature to be highlighted, and/or the location of that feature within the product. In some embodiments, when certain features (those that are capable of providing visually discernable differences) such as display 312 are made visible during the product comparison, differences between the features can be made visually apparent (e.g., visual indicators can be presented) to aid in the product comparison. For example, differences in display resolution between display 312-P and display 312-V can be made noticeable on each of the displays, in some instances in an enhanced or exaggerated fashion to highlight the differences between the displays.

FIG. 3F illustrates yet another comparison of physical product 308 to virtual product representation 306-B according to some embodiments of the disclosure. In some embodiments, in order to assist a user in identifying features capable of being compared using textual indicators 310, one or more feature areas 314 can be highlighted or otherwise made visible on either physical product 308, virtual product representation 306-B, or both, so that the user can see features that are available for comparison when the physical product is sufficiently rotated to expose those feature areas. For example, feature area 314-PA and feature area 314-VA can be presented as an outline or other marking around the visible camera lenses of physical product 308 and virtual product representation 306-B, respectively. Sufficiently exposing those feature areas 314 by rotation (e.g., such that a threshold amount of the feature area is visible) can cause textual indicators 310 for those feature areas to appear. In another embodiment, feature area 314-PB and feature area 314-VB can be presented as an outline or other identifier on the chassis of physical product 308 and virtual product representation 306-B, respectively, to show the location of hidden features (e.g., features hidden within the chassis) that can nevertheless be compared using textual indicators 310. In yet another embodiment, as an alternative to presenting chassis outlines or identifiers for features hidden within the products, these hidden features can instead be virtually presented above physical product 308 and virtual product representation 306-B. For example, rather than presenting feature area 314-PB and feature area 314-VB as an outline on the chassis representing a hidden feature, virtual feature representations 314-PC and 314-VC can be presented above their respective products in an exploded view, with textual indicators (not shown in FIG. 3F) corresponding to those virtual feature representations. Virtual feature representations 314-PC and 314-VC can be two or three dimensional representations of the hidden feature (e.g., a processor, memory, antenna, etc.), and can be images, animations, videos, and the like.

FIG. 3G illustrates yet another comparison of physical product 308 to virtual product representation 306-B according to some embodiments of the disclosure. Unlike FIGS. 3A-3F, in the embodiment of FIG. 3G physical product 308 is being held in the user's right hand rather than the left hand. Upon recognizing that physical product 308 is being held in the user's right hand, virtual product representation 306-B can be located or relocated in a comparison position to the left of the physical product.

To stop the coordinated spatial visual comparison, physical product 308 can be removed from 3D environment 300 so that it no longer appears in the 3D environment. When physical product 308 is removed from 3D environment 300, virtual product representation 306 can return to its product card 302.

In some embodiments, extended reality environments (e.g., such as a 3D environment) are able to provide product information such as ownership information by presenting one or more virtual object information interfaces (e.g., virtual product information cards) in proximity to a physical product, even when the physical product does not have a display of its own. In some embodiments, the virtual product information cards can provide the user with the ability to compare one or more features of the physical product (e.g., the user's currently owned product) to other virtual products (e.g., newer versions of the same product, or different models of a similar product). In some embodiments, the comparison can include a partially or fully immersive experience, as will be described in more detail below.

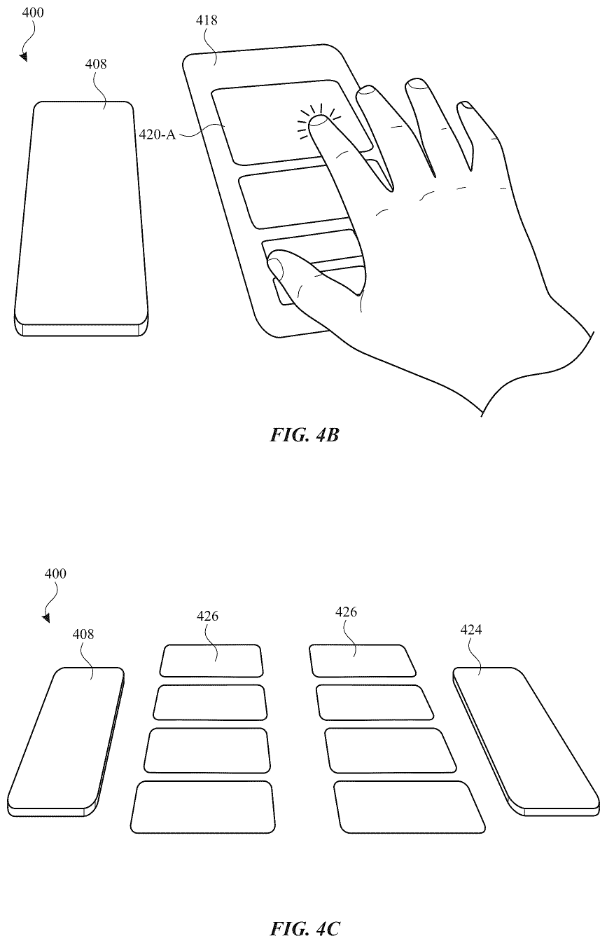

FIG. 4A illustrates 3D environment 400 including physical product 408 and virtual product information card 418 according to some embodiments of the disclosure. In the embodiment of FIG. 4A, 3D environment 400 can be displayed or presented (e.g., provided) by a display generation component of an electronic device (e.g., such as electronic device 100 and/or device 200 described above with respect to FIG. 1 and FIG. 2). To display a virtual object information interface such as a virtual product information card 418, a physical object such as physical product 408 is first brought into view in 3D environment 400. In FIG. 4A, physical product 408 can be a representation of a real-world object in the physical environment in proximity to an electronic device such as a head-mounted device (e.g., the user's hand and the physical product exist in the physical environment). In some embodiments, physical product 408 is displayed by a display generation component in the electronic device by capturing one or more images of the physical product (e.g., using one or more sensors of the electronic device, such as a camera and/or a depth sensor) and displaying a representation of the physical product (e.g., a photorealistic representation, a simplified representation, a caricature, etc.), respectively, in 3D environment 400. In some embodiments, physical product 408 is displayed in 3D environment 400 at a location such that it appears in the same or a similar location as in the real world (e.g., the same distance from the user, from the same perspective, etc.). In some embodiments, physical product 408 is passively provided by the electronic device via a transparent or translucent display (e.g., by not obscuring the user's view of the physical product, thus allowing the physical product to be visible to the user through a transparent or translucent display). Although physical product 408 is illustrated in FIG. 4A as a smartphone, other types of physical products, either electronic or non-electronic, can also be presented.

Physical product 408 can be identified using visual indicators that are displayed, printed, or otherwise visible on or over the physical product (e.g., distinctive physical features, model numbers, serial numbers, QR codes, etc.), or using signals transmitted by the physical product, voice commands, or other inputs that can be received and detected by a head-mounted display or other device, for example. For example, physical product 408 can present a QR code on its physical display, or some other alphanumeric, iconic or symbolic identifier can be permanently presented on a non-display portion of the physical device. In other embodiments the physical product can be previously identified (e.g., known in advance without the need for real-time system inputs). Once physical product 408 is identified, virtual product information card 418 can be retrieved and presented alongside the physical product. Although virtual product information card 418 is shown in FIG. 4A as being generally rectangular, two-dimensional, and arranged on a flat surface, in other embodiments the virtual product information cards can have different shapes, can be three-dimensional, and can be positioned in other ways, such as suspended in 3D environment 400, for example.

Virtual product information card 418 can include product ownership information 428 (e.g., registered owner name, date purchased, model number, serial number, etc.) and one or more affordances such as window affordances 420 (two representative window affordances 420-A and 420-B are shown in FIG. 4A for brevity), each window affordance containing product information for physical product 408, or related to the physical object or product. In some embodiments, window affordances 420 can contain product ownership information such as object replacement (inclusive of upgrade or replacement) information (e.g., object upgrade or replacement program status, available product upgrades), warranty information (e.g., extended warranty plans and status), product configuration information (e.g., operating system version, display type, processor model, memory size, installed applications, etc.), and the like. Window affordances 420 can be selectable to initiate further operations such as presenting further object or product information. Virtual product information card 418 can also include affordances such as button affordances 422 (two representative button affordances 422-A and 422-B are shown in FIG. 4A for brevity) for initiating operations such as presenting further object or product information, obtaining customer support, or purchasing accessories for physical product 408.

In a particular example which is used herein for illustrative purposes, window affordance 420-A can display the product's upgrade program status, window affordance 420-B can display the product's warranty program status, button affordance 422-A can allow a user to obtain product support, and button affordance 422-B can allow a user to browse and purchase a replacement or accessories for physical product 408. However, it should be understood that these information or function assignments represent only one example, and that other information or functions can be assigned to any number of windows and buttons on virtual product information card 418.

FIG. 4B illustrates the selection of window affordance 420-A from within virtual product information card 418 according to some embodiments of the disclosure. FIG. 4B illustrates a user's hand tapping or coming into proximity with window affordance 420-A. Continuing the above example, when the activation of window affordance 420-A presenting upgrade or replacement program status is detected, such as by detecting that a finger or other object is within a threshold proximity of window affordance 420-A, the upgrade or replacement program status for physical product 408 can appear in 3D environment 400. Although not shown in FIG. 4B, button affordances 422 can also be selected in a similar manner.

FIG. 4C illustrates 3D environment 400 displaying further product information presented due to the selection of window affordance 420-A according to some embodiments of the disclosure. Continuing the above example in which window affordance 420-A presenting upgrade or replacement program status is activated, a representation of a virtual upgrade or replacement object, such as virtual product representation 424 of a potential upgrade or replacement product can be presented, along with additional object or product information, which in some embodiments may take the form of one or more windows 426. In some embodiments, information such as windows 426 can present comparison information such as a particular product specification, feature, advantage, characteristic, etc. of the potential upgrade product. In a smartphone example, the presented comparison information can include, but is not limited to, information such as the features of the camera system, battery life, display information (e.g., size, technology and resolution), user identification information (e.g., face recognition, fingerprint detection), environmental resistance information (e.g., water resistance, dust resistance), and processor information (e.g., type, model, technology, manufacturer, speed). However, it should be understood that other product types and other product information can be presented. In some embodiments, windows 426 can only present comparison information common to both physical product 408 and potential upgrade virtual product representation 424, and may include deltas or differences between the two products (e.g., “20% faster processor”), so that the user can efficiently compare the two products.

In some embodiments, some windows 426 can be affordances that, when selected, can cause additional information or windows to be presented, in some instances by replacing windows 426 with additional information or windows. For example, selecting window 426 presenting processor information can result in new information and/or a new set of windows (or additional windows) to be presented in 3D environment 400, with the new windows containing information specific to a processor.

In some embodiments, if affordances other than upgrade program status window affordance 420-A are selected, virtual product representation 424 may not be presented, and instead windows 426 can present other types of information relevant to physical product 408, such as warranty information, support information, or different accessories for potential purchase, for example.

In an alternative embodiment of FIG. 4B in which a window or button affordance presenting accessory information is activated, virtual product representations of one or more product accessories for potential purchase can be presented, along with additional product information, which in some embodiments may take the form of one or more windows. In some embodiments, the information or windows can present accessory information such as accessory specifications, features, advantages, product compatibility, etc.

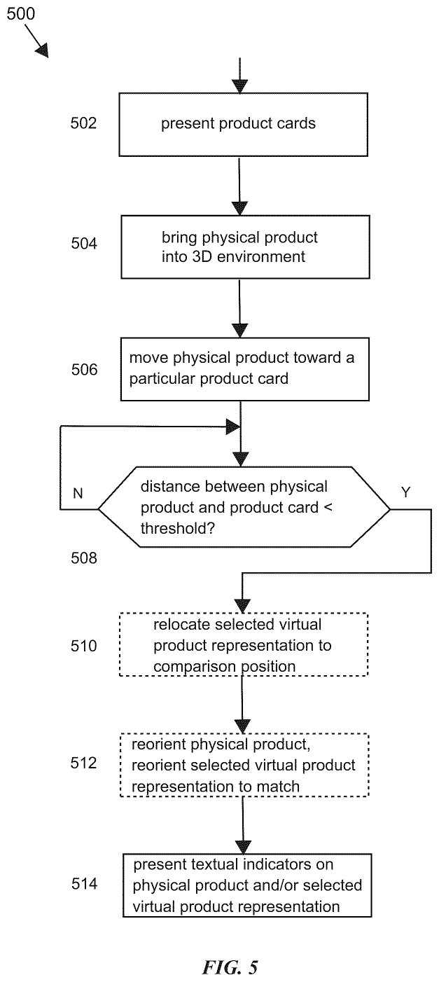

FIG. 5 is a flow diagram illustrating a method 500 of comparing a physical product to a virtual product representation in a 3D environment according to some embodiments of the disclosure. The method 500 is optionally performed at an electronic device such as device 100 and device 200, while displaying products such as in a virtual retail store described above with reference to FIGS. 3A-3G. Some operations in method 500 are optionally combined, the order of some operations is optionally changed, and/or some operations may optionally be skipped. As described below, the method 500 provides methods of comparing features of a physical product and a virtual product representation in a 3D environment in accordance with embodiments of the disclosure (e.g., as discussed above with respect to FIGS. 3A-3G).

In the flow diagram of FIG. 5, one or more product cards are presented in a 3D environment at 502. These product cards can include product information and/or virtual product representations. A physical product can be brought into view in the 3D environment at 504. If needed, the physical product can be identified. The physical product can be moved toward a particular product card at 506. The distance between the physical product and a particular product card (or a virtual product representation associated with that product card) can be monitored at 508, and as long as the distance is above a certain threshold, the monitoring continues. When the distance falls below the threshold, indicating that the physical product has moved to within a selection distance of a particular product card or virtual product representation, a virtual product representation may optionally be relocated to a comparison position at 510. The physical product can optionally be reoriented, with the selected virtual product representation being automatically reoriented to match at 512. Textual indicators associated with one or both of the physical product and the virtual product representation can be presented to provide product comparison information at 514, and as the physical product and the selected virtual product representation are reoriented, different textual indicators can be selectively presented to provide different product comparison information.

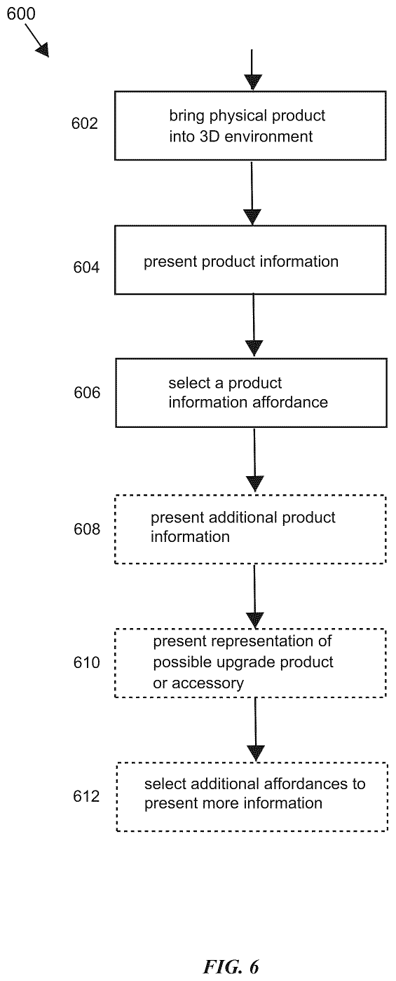

FIG. 6 is a flow diagram illustrating a method 600 of displaying and utilizing product information of a physical product in a 3D environment according to some embodiments of the disclosure. The method 600 is optionally performed at an electronic device such as device 100 and device 200. Some operations in method 600 are optionally combined, the order of some operations is optionally changed, and/or some operations may optionally be skipped. As described below, the method 600 provides methods of displaying and utilizing product information of a physical product in a 3D environment in accordance with embodiments of the disclosure (e.g., as discussed above with respect to FIGS. 4A-4C).

In the flow diagram of FIG. 6, a physical product is first brought into view in a 3D environment at 602. If needed, the physical product can be identified. Product information can be presented at 604. In some embodiments, product information can be presented as windows or buttons on a virtual product information card, and can include ownership information, upgrade information, warranty information, product configuration information, and the like. In some embodiments, a particular product information window or button affordance can be selected at 606. Further product information can then be presented at 608. In some embodiments, a representation of a possible upgrade product or product accessories can be presented at 610. For example, if an upgrade program affordance is selected at 606, upgrade information can be presented at 608, and a representation of a possible product upgrade can be presented at 610. However, if a product accessory affordance is selected at 606, accessory information can be presented at 608, and representations of possible product accessories can be presented at 610. In some embodiments, further affordances can be selected at 612 to hierarchically present further product information.

Therefore, according to the above, some examples of the disclosure are directed to a method, comprising, at an electronic device in communication with a display and one or more input devices, presenting, via the display, a representation of one or more virtual objects in a computer-generated environment, in accordance with detecting a physical object that corresponds to a virtual object of the one or more virtual objects, selecting the virtual object for comparison with the physical object, and presenting, via the display, a representation of the selected virtual object and the physical object at a comparison position defined relative to a position of the physical object. Alternatively or additionally to one or more of the examples disclosed above, in some examples the representation of the one or more virtual objects comprises one or more object cards. Alternatively or additionally to one or more of the examples disclosed above, in some examples the representation of the one or more virtual objects comprises one or more images of the one or more virtual objects. Alternatively or additionally to one or more of the examples disclosed above, in some examples the method further comprises presenting the physical object by causing the physical object to appear in the computer-generated environment. Alternatively or additionally to one or more of the examples disclosed above, in some examples selecting the virtual object for comparison with the physical object is performed further in accordance with detecting movement of the physical object to less than a first threshold distance from a representation of the virtual object. Alternatively or additionally to one or more of the examples disclosed above, in some examples the method further comprises detecting movement of the physical object to less than a second threshold distance from a particular representation of the one or more virtual objects, but greater than a first threshold distance, the second threshold distance greater than the first threshold distance, and in accordance with a determination that the physical object is less than the second threshold distance but greater than the first threshold distance, relocating the particular representation of the one or more virtual objects closer to the physical object. Alternatively or additionally to one or more of the examples disclosed above, in some examples the relocation of the particular representation of the one or more virtual objects closer to the physical object simulates magnetic attraction. Alternatively or additionally to one or more of the examples disclosed above, in some examples the method further comprises relocating the representation of the selected virtual object to appear in the comparison position. Alternatively or additionally to one or more of the examples disclosed above, in some examples the method further comprises causing a copy of the representation of the selected virtual object to appear in the comparison position. Alternatively or additionally to one or more of the examples disclosed above, in some examples the comparison position is to one side of the physical object. Alternatively or additionally to one or more of the examples disclosed above, in some examples the comparison position depends on whether the physical object is being held with a left hand or a right hand. Alternatively or additionally to one or more of the examples disclosed above, in some examples the method further comprises presenting one or more textual indicators associated with one or both of the physical object and the selected virtual object, each textual indicator presenting information for comparing the physical object and the selected virtual object. Alternatively or additionally to one or more of the examples disclosed above, in some examples the method further comprises presenting one or more visual indicators associated with one or both of the physical object and the selected virtual object, each visual indicator presenting information for comparing the physical object and the selected virtual object. Alternatively or additionally to one or more of the examples disclosed above, in some examples the method further comprises detecting a reorientation of the physical object, and reorienting, via the display, the representation of the selected virtual object in accordance with the detected reorientation. Alternatively or additionally to one or more of the examples disclosed above, in some examples the method further comprises, in response to detecting a reorientation of the physical object and reorienting the representation of the selected virtual object, selectively presenting, via the display, one or more textual indicators associated with one or both of the physical object and the representation of the selected virtual object in accordance with a particular surface of the physical object or the representation of the selected virtual object being exposed during the reorientation, each textual indicator presenting information for comparing the physical object and the selected virtual object. Alternatively or additionally to one or more of the examples disclosed above, in some examples the method further comprises, in response to detecting a reorientation of the physical object and reorienting the representation of the selected virtual object, selectively presenting, via the display, one or more textual indicators associated with one or both of the physical object and the representation of the selected virtual object in accordance with a particular feature area on or above the physical object and the representation of the selected virtual object being exposed during the reorientation, each textual indicator presenting information for comparing the physical object and the selected virtual object.

Some examples of the disclosure are directed to an electronic device, comprising one or more processors, memory, and one or more programs, wherein the one or more programs are stored in the memory and configured to be executed by the one or more processors, the one or more programs including instructions for presenting, via a display, a representation of one or more virtual objects in a computer-generated environment, in accordance with detecting a physical object that corresponds to a virtual object of the one or more virtual objects, selecting the virtual object for comparison with the physical object, and presenting, via the display, a representation of the selected virtual object and the physical object at a comparison position defined relative to a position of the physical object.

Some examples of the disclosure are directed to a non-transitory computer readable storage medium storing one or more programs, the one or more programs comprising instructions, which when executed by one or more processors of an electronic device, cause the electronic device to present, via a display, a representation of one or more virtual objects in a computer-generated environment, in accordance with detecting a physical object that corresponds to a virtual object of the one or more virtual objects, select the virtual object for comparison with the physical object, and present, via the display, a representation of the selected virtual object at a comparison position defined relative to a position of the physical object.

Some examples of the disclosure are directed to an electronic device, comprising one or more processors, memory, means for presenting a representation of one or more virtual objects in a computer-generated environment, means for detecting a physical object that corresponds to a virtual object of the one or more virtual objects, means for selecting the virtual object for comparison with the physical object, and means for presenting a representation of the selected virtual object and the physical object at a comparison position defined relative to a position of the physical object.

Some examples of the disclosure are directed to a method, comprising, at an electronic device in communication with a display and one or more input devices, detecting a physical object, in response to detecting the physical object, presenting, in a computer-generated environment via the display, a virtual object information interface including one or more affordances, the one or more affordances including a first affordance presenting first object information for a replacement object corresponding to the detected physical object, and in response to receiving a selection of the first affordance, presenting, via the display, a representation of a virtual replacement object. Alternatively or additionally to one or more of the examples disclosed above, in some examples the method further comprises presenting the physical object by causing the physical object to appear in the computer-generated environment. Alternatively or additionally to one or more of the examples disclosed above, in some examples the method further comprises presenting object ownership information on the virtual object information card. Alternatively or additionally to one or more of the examples disclosed above, in some examples the virtual object information interface further comprises a second affordance comprising a first window affordance selectable to present second object information. Alternatively or additionally to one or more of the examples disclosed above, in some examples the virtual object information interface further comprises a second affordance comprising a first button affordance selectable to present second object information. Alternatively or additionally to one or more of the examples disclosed above, in some examples the method further comprises receiving a selection of the second affordance, and in response to receiving a selection of the second affordance, presenting, via the display, second object information. Alternatively or additionally to one or more of the examples disclosed above, in some examples the second object information includes a third affordance selectable to present third object information. Alternatively or additionally to one or more of the examples disclosed above, in some examples the method further comprises, in response to receiving a selection of the first affordance, presenting, via the display, comparison information for comparing the physical object and the representation of the virtual replacement object. Alternatively or additionally to one or more of the examples disclosed above, in some examples the comparison information is located between the physical object and the representation of the virtual replacement object. Alternatively or additionally to one or more of the examples disclosed above, in some examples the comparison information describes differences between the physical object and the representation of the virtual replacement object. Alternatively or additionally to one or more of the examples disclosed above, in some examples the virtual object information interface further comprises a fourth affordance presenting object accessory information, and the method further comprises receiving a selection of the fourth affordance, in response to receiving a selection of the fourth affordance, presenting, via the display, representations of one or more object accessories. Alternatively or additionally to one or more of the examples disclosed above, in some examples the method further comprises, in response to receiving a selection of the fourth affordance, presenting, via the display, accessory information for the representations of the one or more object accessories. Alternatively or additionally to one or more of the examples disclosed above, in some examples the accessory information is located between the physical object and the representations of the one or more object accessories. Alternatively or additionally to one or more of the examples disclosed above, in some examples the accessory information describes the one or more object accessories.

Some examples of the disclosure are directed to an electronic device, comprising one or more processors, memory, and one or more programs, wherein the one or more programs are stored in the memory and configured to be executed by the one or more processors, the one or more programs including instructions for detecting a physical object, and in response to detecting the physical object, presenting, in a computer-generated environment via the display, a virtual object information interface including one or more affordances, the one or more affordances including a first affordance presenting first object information for a replacement object corresponding to the detected physical object, and in response to receiving a selection of the first affordance, presenting, via the display, a representation of a virtual replacement object.

Some examples of the disclosure are directed to a non-transitory computer readable storage medium storing one or more programs, the one or more programs comprising instructions, which when executed by one or more processors of an electronic device, cause the electronic device to detect a physical object, and in response to detecting the physical object, present, in a computer-generated environment via the display, a virtual object information interface including one or more affordances, the one or more affordances including a first affordance presenting first object information for a replacement object corresponding to the detected physical object, and in response to receiving a selection of the first affordance, presenting, via the display, a representation of a virtual replacement object.

Some examples of the disclosure are directed to an electronic device, comprising one or more processors, memory, means for detecting a physical object, and means for presenting, in response to detecting the physical object, a virtual object information interface including one or more affordances, the one or more affordances including a first affordance presenting first object information for a replacement object corresponding to the detected physical object, and in response to receiving a selection of the first affordance, means for presenting a representation of a virtual replacement object.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method, comprising:
at an electronic device in communication with a display and one or more input devices:
presenting, via the display, a representation of one or more virtual objects in a computer-generated environment;
in accordance with detecting a physical object that corresponds to a virtual object of the one or more virtual objects, selecting the virtual object for comparison with the physical object; and
presenting, via the display, a representation of the selected virtual object at a comparison position defined relative to a position of the physical object.

2. The method of claim 1, wherein the representation of the one or more virtual objects comprises one or more object cards.

3. The method of claim 1, wherein the representation of the one or more virtual objects comprises one or more images of the one or more virtual objects.

4. The method of claim 1, wherein selecting the virtual object for comparison with the physical object is performed further in accordance with detecting movement of the physical object to less than a first threshold distance from a representation of the virtual object.

5. The method of claim 1, further comprising:
detecting movement of the physical object to less than a second threshold distance from a particular representation of the one or more virtual objects, but greater than a first threshold distance, the second threshold distance greater than the first threshold distance; and
in accordance with a determination that the physical object is less than the second threshold distance but greater than the first threshold distance, relocating the particular representation of the one or more virtual objects closer to the physical object.

6. The method of claim 5, wherein the relocation of the particular representation of the one or more virtual objects closer to the physical object simulates magnetic attraction.

7. The method of claim 1, further comprising presenting one or more indicators associated with one or both of the physical object and the selected virtual object, each visual indicator presenting information for comparing the physical object and the selected virtual object.

8. The method of claim 1, further comprising:
detecting a reorientation of the physical object;
reorienting, via the display, the representation of the selected virtual object in accordance with the detected reorientation; and
in response to detecting a reorientation of the physical object and reorienting the representation of the selected virtual object:
selectively presenting, via the display, one or more textual indicators associated with one or both of the physical object and the representation of the selected virtual object in accordance with a particular surface of the physical object or the representation of the selected virtual object being exposed during the reorientation or in accordance with a particular feature area on or above the physical object or the representation of the selected virtual object being exposed during the reorientation, each textual indicator presenting information for comparing the physical object and the selected virtual object.

9. An electronic device, comprising:
one or more processors;
memory; and
one or more programs, wherein the one or more programs are stored in the memory and configured to be executed by the one or more processors, the one or more programs including instructions for:
presenting, via a display, a representation of one or more virtual objects in a computer-generated environment;
in accordance with detecting a physical object that corresponds to a virtual object of the one or more virtual objects;
selecting the virtual object for comparison with the physical object; and
presenting, via the display, a representation of the selected virtual object at a comparison position defined relative to a position of the physical object.

10. The electronic device of claim 9, wherein the representation of the one or more virtual objects comprises one or more object cards.

11. The electronic device of claim 9, wherein the representation of the one or more virtual objects comprises one or more images of the one or more virtual objects.

12. The electronic device of claim 9, wherein selecting the virtual object for comparison with the physical object is performed further in accordance with detecting movement of the physical object to less than a first threshold distance from a representation of the virtual object.

13. The electronic device of claim 9, the one or more programs further including instructions for:
detecting movement of the physical object to less than a second threshold distance from a particular representation of the one or more virtual objects, but greater than a first threshold distance, the second threshold distance greater than the first threshold distance; and
in accordance with a determination that the physical object is less than the second threshold distance but greater than the first threshold distance, relocating the particular representation of the one or more virtual objects closer to the physical object.

14. The electronic device of claim 13, wherein the relocation of the particular representation of the one or more virtual objects closer to the physical object simulates magnetic attraction.

15. The electronic device of claim 9, the one or more programs further including instructions for presenting one or more indicators associated with one or both of the physical object and the selected virtual object, each visual indicator presenting information for comparing the physical object and the selected virtual object.

16. The electronic device of claim 9, the one or more programs further including instructions for:
detecting a reorientation of the physical object;
reorienting, via the display, the representation of the selected virtual object in accordance with the detected reorientation; and
in response to detecting a reorientation of the physical object and reorienting the representation of the selected virtual object:
selectively presenting, via the display, one or more textual indicators associated with one or both of the physical object and the representation of the selected virtual object in accordance with a particular surface of the physical object or the representation of the selected virtual object being exposed during the reorientation or in accordance with a particular feature area on or above the physical object or the representation of the selected virtual object being exposed during the reorientation, each textual indicator presenting information for comparing the physical object and the selected virtual object.

17. A non-transitory computer readable storage medium storing one or more programs, the one or more programs comprising instructions, which when executed by one or more processors of an electronic device, cause the electronic device to:
present, via a display, a representation of one or more virtual objects in a computer-generated environment;
in accordance with detecting a physical object that corresponds to a virtual object of the one or more virtual objects;
select the virtual object for comparison with the physical object; and
present, via the display, a representation of the selected virtual object at a comparison position defined relative to a position of the physical object.

18. The non-transitory computer readable storage medium of claim 17, wherein the representation of the one or more virtual objects comprises one or more object cards.

19. The non-transitory computer readable storage medium of claim 17, wherein the representation of the one or more virtual objects comprises one or more images of the one or more virtual objects.

20. The non-transitory computer readable storage medium of claim 17, wherein selecting the virtual object for comparison with the physical object is performed further in accordance with detecting movement of the physical object to less than a first threshold distance from a representation of the virtual object.

21. The non-transitory computer readable storage medium of claim 17, the instructions, when executed by one or more processors, further cause the electronic device to:
detect movement of the physical object to less than a second threshold distance from a particular representation of the one or more virtual objects, but greater than a first threshold distance, the second threshold distance greater than the first threshold distance; and
in accordance with a determination that the physical object is less than the second threshold distance but greater than the first threshold distance, relocate the particular representation of the one or more virtual objects closer to the physical object.

22. The non-transitory computer readable storage medium of claim 21, wherein the relocation of the particular representation of the one or more virtual objects closer to the physical object simulates magnetic attraction.

23. The non-transitory computer readable storage medium of claim 17, the instructions, when executed by one or more processors, further cause the electronic device to present one or more indicators associated with one or both of the physical object and the selected virtual object, each visual indicator presenting information for comparing the physical object and the selected virtual object.

24. The non-transitory computer readable storage medium of claim 17, the instructions, when executed by one or more processors, further cause the electronic device to:
detect a reorientation of the physical object;
reorient, via the display, the representation of the selected virtual object in accordance with the detected reorientation; and
in response to detecting a reorientation of the physical object and reorienting the representation of the selected virtual object:
selectively present, via the display, one or more textual indicators associated with one or both of the physical object and the representation of the selected virtual object in accordance with a particular surface of the physical object or the representation of the selected virtual object being exposed during the reorientation or in accordance with a particular feature area on or above the physical object or the representation of the selected virtual object being exposed during the reorientation, each textual indicator presenting information for comparing the physical object and the selected virtual object.
